(19) United States
(12) Patent Application Publication
(10) Pub. No.: US 2007/0162663 A1
(43) Pub. Date: Jul. 12, 2007

(54) Single-chip multiple-microcontroller package structure

(76) Inventor: Tsan-Bih Tang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/401,255

(22) Filed: Apr. 11, 2006

Related U.S. Application Data
(63) Continuation-in-part of application No. 11/295,578, filed on Dec. 7, 2005.

(51) Int. Cl. G06F 13/38

(52) U.S. Cl. 710/62

(57) ABSTRACT

A multiple-microcontroller integrated circuit chip comprises at least two microcontrollers capable of operating independently, a plurality of pins, a data bus, a pin multiple-control register, and a plurality of pin control logics. The pin multiple-control register, the data bus, and the pin control logics are electrically connected to the pins. The microcontrollers can be functionally connected to at least one predetermined pin so that the microcontrollers may read the setting status of the pin to check whether the pin is available, and to set the functional mode or the attributes, of the pin. The multiple-microcontroller integrated circuit chip can therefore provide more functions and higher flexibility with the least number of pins.

### REFERENCE TO RELATED APPLICATIONS

This Patent Application is a Continuation-in-Part of U.S. patent application Ser. No. 11/295,578, filed on 7 Dec. 2005, now pending.

### BACKGROUND OF THE INVENTION

1. Field of the invention

The present invention relates to an integrated circuit having a single chip package structure and, more particularly, to a multiple-microcontroller integrated circuit chip having a single chip package structure.

2. Description of Related art

Single chip microcontrollers have gradually replaced the role of conventional electronic circuits or logic circuits in the automation field because of their higher integration, simpler hardware structure, lower power consumption, and higher flexibility. They are widely applied in various industries, home electric products or equipments, and so on. Apparently, single chip microcontrollers will become the most important main control elements for future automation. Moreover, as the requirements of compactness of electric products increase, a single chip microcontroller is required to provide as many functions as possible with the smallest package size, and therefore, more functions need to be provided at a single pin.

In order to fulfill demands from different applications and interfaces, a microcontroller circuit chip usually has some pins with specific functions and some general purpose IO (GPIO) pins. Customers are allowed to set the function of a GPIO pin according to their demands. Thus, to enhance the GPIO function, it is necessary to provide more pin control methods and more operational functions of microcontrollers for setting the function of the pin. Today's microcontrollers can be divided into 8-bit, 16-bit, and 32-bit series. The larger bit number is, the more complicated the usable instruction set would be, and more functions are available.

A package structure 10 of a conventional single chip microcontroller is shown in FIG. 1. The package structure 10 has a microcontroller 12 and a plurality of GPIO pins (e.g., pin 14). As shown in FIG. 1, the microcontroller 12 sets the input output mode of the GPIO pins (e.g., pin 14) via a pin control register 11. For data transmission, the microcontroller 12 selects a corresponding pin 14 via a data bus 18 and a pin control logic 16, to accomplish the transmission. In the package structure 10, the microcontroller 12 may be programmed to control the functions of the pin 14. However, no other microcontrollers may control this pin 14. Pin 14 is exclusively controlled by the microcontroller 12.

The present invention aims to propose a multiple-microcontroller integrated circuit having a single-chip package structure, in which at least two microcontrollers in the multiple-microcontroller can control the same pin, and can change the functions of the pin according to the requirements of the system specification. As compared to the prior art, the present invention can provide more functions and is thus much more flexible.

### SUMMARY OF THE INVENTION

An object of the present invention is to provide a multiple-microcontroller integrated circuit having a single chip package structure, in which at least two microcontrollers can be electrically connected to the same pin so that the pin can be dynamically controlled by more than one microcontrollers for multiple functions.

Another object of the present invention is to provide a multiple-microcontroller integrated circuit having a single chip package structure, in which the function of at least a pin can be dynamically changed by more than one microcontrollers, so that the pin can generate a desired function according to a corresponding microcontroller.

According to the present invention, an integrated circuit chip comprises at least two microcontrollers and a plurality of input/output pins. The microcontrollers are electrically connected to the plurality of pins via a data bus and a plurality of pin control logics. Of the plurality of pins, there is at least one predetermined pin that can be controlled by more than one microcontrollers. Each of the more than one microcontrollers is connected to a pin multiple-control register, so that the microcontroller may read the current setting status of the at least one predetermined pin, check whether the pin is available, and set the functional mode of the pin. If the integrated circuit has three or more microcontrollers, it is not necessary for all of the microcontrollers to be able to control the same predetermined pin. It is possible that only a subset of the microcontrollers are functionally connected to the same predetermined pin to control it. Preferably, each of the microcontrollers functionally connected to the same predetermined pin can dynamically change the function of the pin to control its operations.

### BRIEF DESCRIPTION OF THE DRAWINGS

The various objects and advantages of the present invention will be more readily understood from the following detailed description when read in conjunction with the appended drawing, in which:

FIG. 1 is a package structure diagram of a conventional single chip microcontroller; and

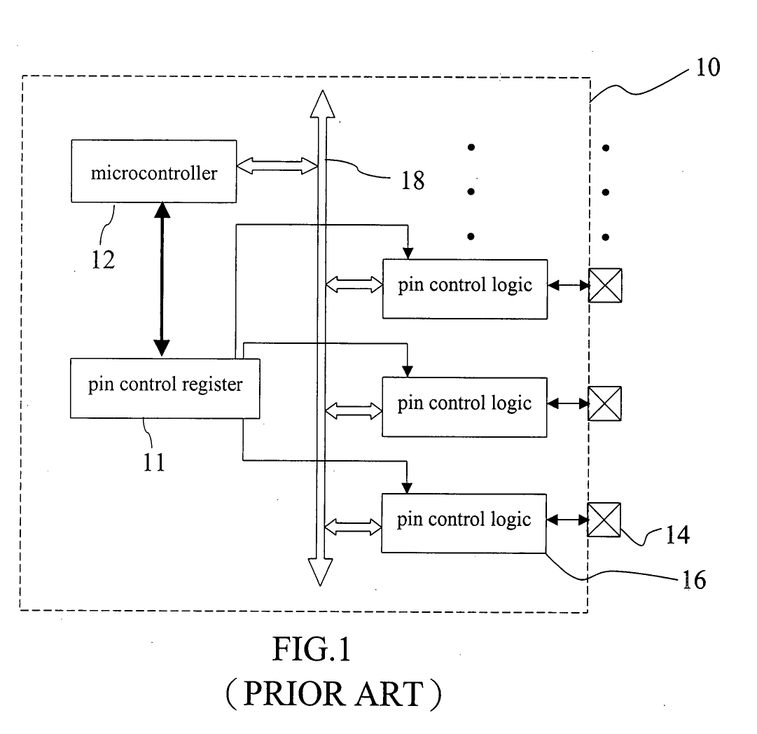

FIG. 2 is a diagram of a single chip package structure of the present invention.

### DETAILED DESCRIPTION OF THE PREFERRED EMBODIMENTS

The present invention proposes a multiple-microcontroller integrated circuit chip, in which at least two microcontrollers in the chip can be functionally connected to the same pin, that is, each of the at least two microcontrollers can dynamically access the same pin through a program executed in the microcontroller, to control the pin. “To control the pin” means to set the functional mode of the pin, or to set the attribute of the pin. For example, the functional mode of the pin may be set to, but not limited to, “input-only” in which the pin acts as an input-only pin, “output-only” in which the pin acts as an output-only pin, “tri-state” in which the pin may switch among three states (input, output, and floating), “pull-high” in which the voltage level of the pin is pulled to a relatively high level, “pull-low” in which the voltage level of the pin is pulled to a relatively low level, “open drain” in which the pin can be driven to a relatively low voltage level when output data is low, or set to floating when output data is high, and so-on, as required. The attributes of the pin, including but not limited to trigger level, driving strength, slew rate, and so on, may also be controlled by each of the at least two microcontrollers. Thereby, the present invention provides more functions at a single pin, so that the multiple-microcontroller integrated circuit chip is available for a much wider range of applications.

By way of example, the present invention is now described below with three microcontrollers.

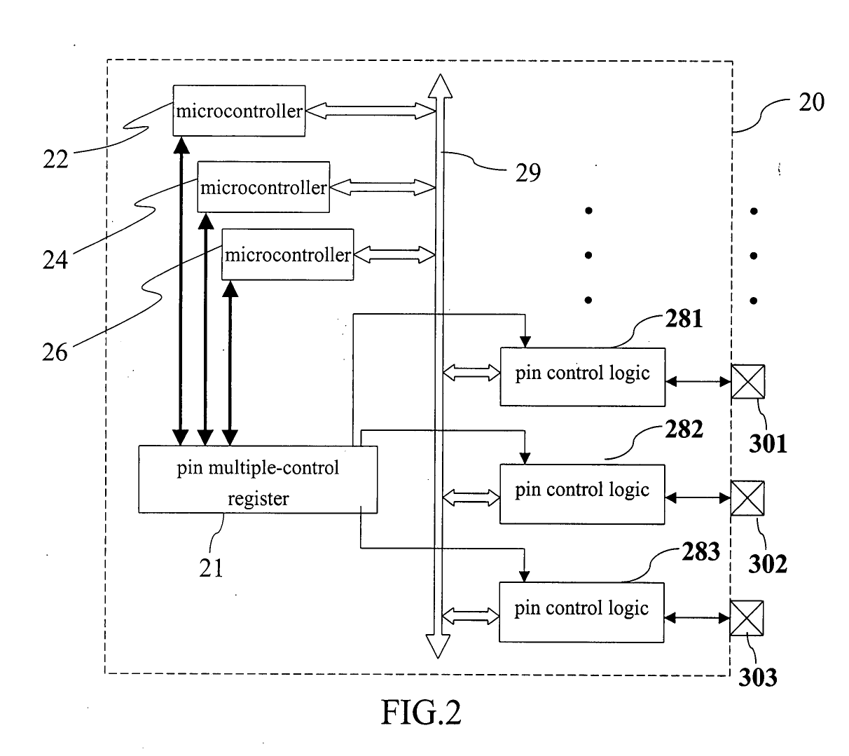

As shown in FIG. 2, a multiple-microcontroller integrated circuit chip 20 according to a preferred embodiment of the present invention comprises three microcontrollers (a first microcontroller 22, a second microcontroller 24 and a third microcontroller 26), a pin multiple-control register 21, a data bus 29, a number of pins 301-303, and a corresponding number of pin control logics 281-283. Each of the microcontrollers 22, 24 and 26 is connected to the pin multiple-control register 21, so that the microcontroller may read the current setting status of a pin to check whether the pin is available, and to set the functional mode or the attributes of the pin. Each of the microcontrollers 22, 24 and 26 is also connected to the data bus 29. The pin control logics 281-283 are connected to the data bus, and electrically connect the microcontrollers 22, 24 and 26 to the pins 301-303 for data transmission between the microcontrollers 22, 24 and 26 and the pins 301-303. Unlike conventional single-microcontroller or multiple-microcontroller integrated circuits, the pins 301-303 are not exclusively controlled by only one or a corresponding microcontroller. According to this embodiment of the present invention, at least a predetermined one of the pins, e.g., pin 303, may be controlled by all of the microcontrollers 22, 24 and 26. As shown in the figure, the microcontrollers 22, 24 and 26 can be dynamically connected to the pin 303 to control its function or attribute by means of the pin multiple-control register 21. In details, when the first microcontroller 22 intends to take control of the pin 303, the first microcontroller 22 reads the content of the pin multiple-control register 21 to retrieve the current status of the pin 303, and then sets the functional mode or attribute of the pin 303. The content of the pin multiple-control register 21 is correspondingly changed. Then, the first microcontroller 22 performs external data transmission through the pin 303, via the data bus 29 and the corresponding pin control logic 283. Next, assuming the second microcontroller 24 intends to take control of the pin 303, the second microcontroller 24 reads the content of the pin multiple-control register 21 to retrieve the current status of the pin 303, and then sets the functional mode or attribute of the pin 303. The content of the pin multiple-control register 21 is thus changed again to correspond to the setting from the second microcontroller 24. Then, the second microcontroller 24 performs external data transmission through the pin 303, via the data bus 29 and the corresponding pin control logic 283. Further next, assuming the third microcontroller 26 intends to take control of the pin 303, the third microcontroller 26 reads the content of the pin multiple-control register 21 to retrieve the current status of the pin 303, and then sets the functional mode or attribute of the pin 303. The content of the pin multiple-control register 21 is once more changed to correspond to the setting from the third microcontroller 26. Then, the third microcontroller 26 performs external data transmission through the pin 303, via the data bus 29 and the corresponding pin control logic 283.

In the above description, only one pin 303 is capable of being controlled by more than one microcontroller. But of course, more or all of the pins may be arranged in a likely manner. This feature gives the multiple microcontroller circuit chip maximum flexibility. Depending on applications, the microcontrollers may be programmed so that, for example, (1) during a certain period of time for certain tasks, pins 301-303 are each exclusively controlled by a corresponding one of the microcontrollers 22-26; (2) during another period of time for different tasks, one or more of the pins 301-303 are dynamically controlled by microcontrollers 22-26, while the rest of the pins are each exclusively controlled by one microcontroller; and (3) during a further other period of time, within one task, one or more of the pins 301-303 are dynamically controlled by microcontrollers 22-26, while the rest of the pins are each exclusively controlled by one microcontroller.

In the above embodiment, all three microcontrollers 22, 24 and 26 in the integrated circuit chip 20 can connect and control the pin 303. Of course it is not necessarily so. In some of the applications, it suffices that only a subset of the microcontrollers, e.g., two out of three, are able to control the pin 303.

In addition, in the above embodiment, the pin multiple-control register 21 is shown as an independent circuit block. However, those of ordinary skill in the art may readily think of equivalent modifications. For example, the function of the pin multiple-control register 21 may be built into one or a number of the microcontrollers as an embedded unit, or built in combination with one or a number of the pin control logic 281-283. Such modifications should of course belong to the scope of the present invention.

And, in the above embodiment, the predetermined pin 303 is described as a functional pin. However, it should be apparent to those of ordinary skill in the art that the predetermined pin 303 may be set simply as an idle pin without any function. Or, for better circuit stability, the pin may preferably be set to a fixed voltage level.

Moreover, although an integrated circuit chip is shown as a preferred embodiment, the present invention can also be applied to chip on board (COB) structures.

Although the present invention has been described with reference to the preferred embodiment thereof, it should be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defmed in the appended claims.

I claim:

1. An integrated circuit chip comprising:
a plurality of pins for use as input/output contacts;
a plurality of microcontrollers;
a data bus used for data transmission among said microcontrollers and said pins;
a pin multiple-control register electrically connected to at least two of said microcontrollers to receive settings from said at least two microcontrollers for controlling at least a predetermined one of said pins; and
a plurality of pin control logics electrically connected to said plurality of pins, and also electrically connected to said plurality of microcontrollers to receive settings for said plurality of pins, wherein at least one of said pin control logics is electrically connected to said pin multiple-control register to receive said settings from said at least two microcontrollers for controlling said predetermined one of said pins, and also electrically connected to said data bus for data transmission between said at least two microcontrollers and said predetermined one of said pins.

2. The integrated circuit chip as claimed in claim 1, wherein two or more of said plurality of pins are each capable of being controlled by said at least two microcontrollers.

3. The integrated circuit chip as claimed in claim 1, which comprises three or more said microcontrollers, and at least two of said microcontrollers are electrically connected to said predetermined pin.

4. The integrated circuit chip as claimed in claim 1, wherein said predetermined pin is a multifunctional pin, and its function can be dynamically changed by at least two of said microcontrollers.

5. The integrated circuit chip as claimed in claim 4, wherein said predetermined pin is a multifunctional pin, and its function can be dynamically changed by any of said microcontrollers.

6. The integrated circuit chip as claimed in claim 4, wherein the function of said predetermined pin is changed by a program executed by one of said microcontrollers controlling said pin.

7. The integrated circuit chip as claimed in claim 2, wherein said settings from said at least two microcontrollers set the state of said predetermined pin to at least one of the states selected from the group consisting of: input pin, output pin, tri-state pin, pull-high pin, pull-low pin, and open drain pin.

8. The integrated circuit chip as claimed in claim 2, wherein said settings from said at least two microcontrollers set at least one of the following attributes of said predetermined pin: trigger level, driving strength, or slew rate.

9. An integrated circuit chip comprising:
a plurality of pins for use as input/output contacts;
at least two microcontrollers;
a data bus used for data transmission among said microcontrollers and said pins; and
a plurality of pin control logics connected to said data bus to receive settings from said microcontrollers for said pins, wherein at least a predetermined one of said plurality of pins is capable of receiving settings from at least two of said microcontrollers.

10. The integrated circuit chip as claimed in claim 9, wherein said predetermined pin is a multifunctional pin, and its function can be dynamically changed by at least two of said microcontrollers.

11. The integrated circuit chip as claimed in claim 9, wherein said predetermined pin is a multifunctional pin, and its function can be dynamically changed by any of said microcontrollers.

12. The integrated circuit chip as claimed in claim 9, wherein said settings from said at least two microcontrollers set the state of said predetermined pin to at least one of the states selected from the group consisting of: input pin, output pin, tri-state pin, pull-high pin, pull-low pin, and open drain pin.

13. The integrated circuit chip as claimed in claim 9, wherein said settings from said at least two microcontrollers set at least one of the following attributes of said predetermined pin: trigger level, driving strength, or slew rate.

14. The integrated circuit chip as claimed in claim 9, wherein at least one of said microcontrollers has embedded therein a pin multiple-control register to receive settings for controlling said predetermined pin.

15. The integrated circuit chip as claimed in claim 9, wherein at least one of said pin control logics has embedded therein a pin multiple-control register to receive settings for controlling said predetermined pin.
